(19) United States
(12) Patent Application Publication
(10) Pub. No.: US 2021/0049531 A1
(43) Pub. Date: Feb. 18, 2021

(54) Automatic calendar event entry creation and modification

(71) Applicant: Avaya Inc., Santa Clara, CA (US)

(72) Inventors: Ranga Bhargavan Sudarsanam, Pune (IN); Sameer Prabhakar Joshi, Pune (IN); Sunil Saraff, Pune (IN)

(21) Appl. No.: 16/538,215

(22) Filed: Aug. 12, 2019

(51) Int. Cl. G06Q 10/06; G06Q 10/10

(52) U.S. Cl. CPC G06Q 10/06314; G06Q 10/1095

(57) ABSTRACT

Calendaring applications are common tools to schedule a resource, such as a person or a device. Often calendars have inaccurate entries where events are scheduled but not attended, in whole or in part, or attended but not on a schedule. As a result, a scheduled resource may appear allocated when available or vice versa. By utilization device logs and comparing entries in a calendar database, actual availability and/or utilized events may be determined and the calendar data entries updated to reflect actual utilization (or lack thereof).

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for automatic calendar entries and particularly to monitoring systems and other event logs to correct or update availability information.

### BACKGROUND

Calendar systems have evolved from manually making entries on paper to sophisticated electronic components that may incorporate presence information. For individuals that have few events, most any system will suffice and entries or updates may be infrequent or entirely absent. However, for those that have many calendar events and/or a continuous stream of updates, having timely and accurate calendar information may be critical—especially for high value or high-consequence events, as well as to incorporate or inform other users and systems that wish to create a calendar event for a particular resource.

### SUMMARY

For many users of calendar applications, calendars can become cluttered with meetings that are accepted, and added to the calendar, but not attended. While some events, such as meetings, are important, others are not so important and may be attended on a “time permitting” basis or not attended at all. This can clutter a calendar with unnecessary meetings that the person will not attend.

Users may not attend a recurring event, such as a regularly scheduled meeting, and the calendar of that person will show the user is busy during that time period. In another scenario, the user could be attending a recurring event, such as making regular calls or attending meetings on a particular day of the week and time, but the meeting is not present in his/her calendar. As a result, others may perceive that the time slot as available. Certain meetings, such as when only bridge information is provided and no invite for meeting exist, also falls into this category.

In one embodiment, systems and methods are provided that utilize device utilization records, such as call logs, time and calendar database entries. Modifications to the calendar, such as to add/update/remove a particular event in a user's calendar is then provided. Users may also be provided with, and utilize, an option to override a particular modification.

In one embodiment, if a call log shows that the user is not attending a particular recurring event such as a meeting, which is present in the calendar database, then subsequent instances may be amended or removed from the user's calendar. For example, a pop-up message may be presented in a collaboration client, asking the user, if he/she wants to remove/update the appointment/meeting from his/her calendar or perform the operation without human intervention. The modification may include, among other things, marking one or more subsequent events as “tentative.”

In another embodiment, if the call log shows that the user is regularly on a call with a particular number or server on a particular day at recurring intervals, a calendar event may be created for subsequent instances of the event. For example, a pop-up can be shown asking the user if he/she wants to add this into the meeting calendar, confirm after the addition has been made, or add the event without human intervention.

As used herein, “calendar” refers to records maintained in at least one data repository in a machine-readable form that may be presented to a user, via a human input-output device which may further be executing a calendar application or a configured generic application (e.g., web browser) to provide calendar data, and/or receive inputs to add, delete, or modify entries maintained in the data repository.

These and other needs are addressed by the various embodiments and configurations of the present invention. The present invention can provide a number of advantages depending on the particular configuration. These and other advantages will be apparent from the disclosure of the invention(s) contained herein.

In one embodiment, a system is disclosed, comprising: a computer having at least one processor and memory accessible to the at least one processor; a device utilization repository comprising a device utilization record of a device provided by the device that is paired with a scheduled resource; a calendar data repository comprising scheduled activities of the scheduled resource; wherein the computer performs a determination of a discrepancy between attendance of a recurring scheduled activity and device utilization record concurrent with the recurring scheduled activity; and wherein upon determining the discrepancy, the computer, performs a modification to a subsequent instance of the recurring scheduled activity, wherein the modification attenuates the difference between the recurring scheduled activity and the device utilization record.

In another embodiment, a method is disclosed, comprising: accessing a device utilization repository comprising a device utilization record of a device provided by a device paired with a scheduled resource; accessing a calendar data repository comprising scheduled activities of the scheduled resource; performing a first determination of non-attendance of the scheduled resource of at least a portion of a first instance of a recurring scheduled activity upon determining the first instance of the recurring scheduled activity differs from the device utilization record; and upon the first determination of non-attendance, performing a modification to a subsequent instance of the recurring scheduled activity, wherein the modification attenuates the difference between the recurring scheduled activity and the device utilization record.

In another embodiment, a method is disclosed, comprising: accessing a device utilization repository comprising a device utilization record of the device provided by a device paired with a scheduled resource; accessing a calendar data repository comprising scheduled activities of the scheduled resource; performing a first determination of attendance by the scheduled resource of a first candidate event, wherein the scheduled activities of the scheduled resource do not indicate attendance of the first candidate event by the scheduled resource; performing a second determination of attendance by the scheduled resource of a second candidate event, wherein the scheduled activities of the scheduled resource do not indicate attendance of the second candidate event; determining the first candidate event and the second candidate event comprise instances of a recurring scheduled activity; and upon the first candidate event and the second candidate event are instances of the same recurring scheduled activity, performing a modification to a subsequent instance of the recurring scheduled activity, wherein the modification provides indicia of attendance of the subsequent instance of the recurring scheduled activity.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first data structure in accordance with embodiments of the present disclosure;

FIG. 3 depicts a second data structure in accordance with embodiments of the present disclosure;

FIG. 4 depicts a third data structure in accordance with embodiments of the present disclosure;

FIG. 5 depicts a fourth data structure in accordance with embodiments of the present disclosure;

FIG. 6 depicts a fifth data structure in accordance with embodiments of the present disclosure;

FIG. 7 depicts a sixth data structure in accordance with embodiments of the present disclosure;

FIG. 8 depicts a seventh data structure in accordance with embodiments of the present disclosure;

FIG. 9 depicts a first process in accordance with embodiments of the present disclosure;

FIG. 10 depicts a second process in accordance with embodiments of the present disclosure; and

FIG. 11 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

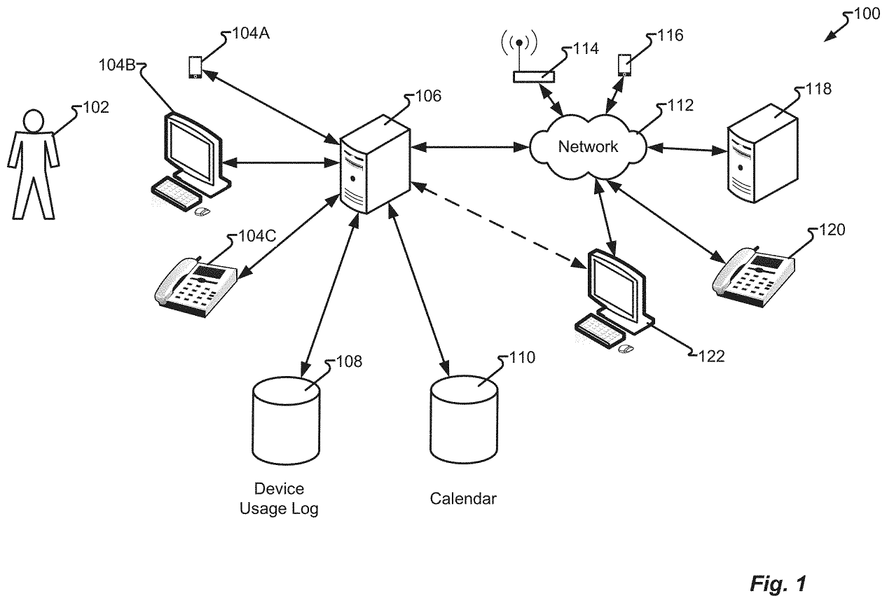

FIG. 1 depicts system 100 in accordance with embodiments of the present disclosure. In one embodiment, system 100 illustrates one topology of networked components. It should be appreciated that certain components of system 100 may be combined, further separated, and/or linked to form different topologies. In one embodiment, two or more of device 104, computer 106, device utilization repository 108, calendar data repository 110 may comprise a single device, such as device 104B, which may be embodied as a computer with a network interface to network 112 or other device that may indicate utilization of device 104.

Device 104 is variously embodied and may comprise device 104A, embodied as a mobile telephone having voice only, text only, data only, or a combination of two or more of voice, text, and data; device 104B embodied as a personal computer having a one or more communication and data processing abilities (e.g., voice, video, text chat, document sharing, co-browsing, etc.); and device 104C is embodied as a voice only telephone (e.g., plain old telephone system or POTS). Device 104 may also be embodied in other form capable of creating, or causing the creation, of a record of utilization and/or location of scheduled resource 102, such as an access control device (e.g., security panel, access card, card reader, etc.) to a room, building, or area. In another embodiment, device 104 may comprise a location reporting device, such as a wireless communication device that accesses specific a location, such as device 114, which may be embodied as a WiFi access point, that provides location of device 104, and therefore scheduled resource 102, to be (or not be) within a particular area. In another embodiment, device 104 may comprise an access-controlled device (e.g., machine, vehicle, etc.) that reports whether scheduled resource 102 is (or is not) engaged therewith. As will be discussed more completely with respect to the embodiments that follow, knowing that scheduled resource 102 is utilizing, and therefore within a limited distance from, location dependent device 114 then it may be known that scheduled resource 102 is within a particular area, such as attending a scheduled meeting co-located with location dependent device 114. Conversely, if scheduled resource 102 is utilizing a particular device 104 to utilize location dependent device 114, then scheduled resource 102 may be determined to not be at a different location, such as a meeting location associated with a different location dependent device 114.

In other embodiments, other network topologies may be utilized without departing from the scope of the embodiments herein. For example, combining of two or more components into a single device, including but not limited to, device 104, computer 106, device utilization repository 108, calendar data repository 110 and/or other components. While computer 106 may communicate with participant device 122 via network 112, in other embodiments components, such as participant device 122 may be more directly connect (e.g., ports of a common device, internal network, direct connection, etc.) to computer 106. While device 104 may connect to host 118, host 118 may in turn connect to other participant devices, which may include participant device 116, participant device 120, and participant device 122. In yet another embodiment, computer 106 may be, or have the functionality of host 118, whereby other participant devices are connected via network 112 to host 118 co-integrated with computer 106.

Device 104 may be, comprise, be comprised, or be discrete from computer 106. Computer 106 comprises at least one processor with access to a memory for the execution of instructions to process data, including the execution of instructions of an algorithm whereby data is accessed from device utilization repository 108 and calendar data repository 110, which may be combined into a single repository, to determine whether a discrepancy exists in the utilization of device 104 and recurring events maintained in calendar data repository 110. As a result, the availability of scheduled resource 102 may be determined to be in agreement with the utilization of device 104 or whether a discrepancy exists. If a discrepancy is determined, a modification to calendar data repository 110 may be performed to attenuate or eliminate the discrepancy.

In another embodiment, scheduled resource 102 is paired to a particular device 104 whereby the usage of device 104 is known, with at least reasonably certainty (e.g., usage by others would be incidental or the result of fraudulent impersonation), to be utilized only by scheduled resource 102. This may be achieved by placing device 104 on scheduled resource 102 (e.g., a human carrying cellular telephone, security access card, etc.), by login (e.g., a common computer but configured to be utilized only by a specific user who is identified by sign-in or other authentication process), etc. Accordingly, device 104 may be assumed to be utilized by only, and therefore paired to, scheduled resource 102.

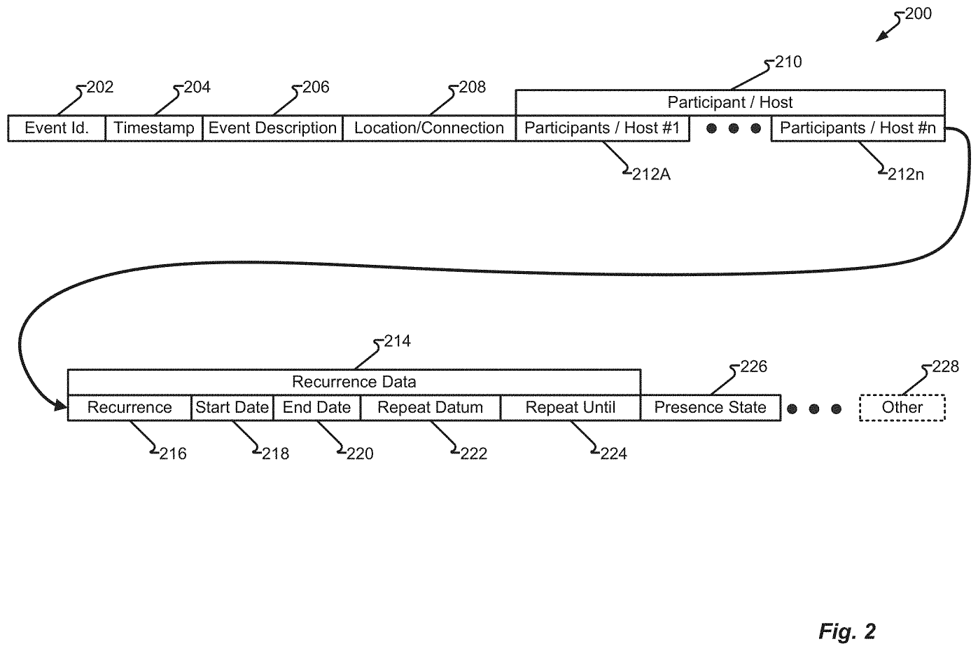

FIG. 2 depicts data structure 200 in accordance with embodiments of the present disclosure. In one embodiment, data structure 200 is utilizes to store records for scheduled events associated with scheduled resource 102, which may be maintained in calendar data repository 110. Data structure 200 is accessed and/or created by at least on processor, such as a processor of computer 106 and/or device 104, when present in device 104. Data structure 200 comprises records for storing data associated with calendar events which may include recurring scheduled events.

In one embodiment, data structure 200 comprises an event identification field 202, such record number or other unique identifier, timestamp field 204 comprises a data and/or time identifier, such as when a particular recurring event is scheduled to begin, end, begin with a duration, etc. Event description field 206 may maintain a description, such as a subject of a meeting, notes, agenda, etc. Location/connection 208 may maintain a location (e.g., conference room, building, office, customer identifier, etc.) or connection (e.g., bridge number, electronic conference identifier, telephone number, etc.) for meetings conducted utilizing networked components (e.g., device 104 and network 112). Participant/host block 210 may comprise entries for each participant, each known participant, host, etc. in participant/host fields 212A-212n. Recurrence datum 214 may be null or absent for non-recurring events, however, for recurring events, recurrence field 216 may be a flag, identifier or other identifier that a particular entry in data structure 200 is a recurring scheduled event. Start date field 218 may indicate a first instance of the recurring scheduled event. End date field 220, if not null, may indicate the data after which no further instances of the scheduled event will occur.

Repeat datum field 222 comprises a data structure indicating the criterion or criteria for the recurrence of the recurring scheduled event. For example, repeat datum field 222 may indicate that a recurring scheduled event is to be repeated, every Monday and Wednesday; every day, the first Monday of the month, the second Tuesday of the quarter, the Friday before a scheduled product release, the second work-day following receipt of monthly sales figures, etc. As a result of the data and/or rules within repeat datum field 222, a recurring scheduled event may be date-triggered (e.g., daily, weekly, monthly, quarterly, yearly, second Monday of the month, etc.) and/or event triggered (e.g., first work-day following senior staff meeting, one week before product release, etc.). While embodiments herein are generally directed to meetings that are consistent with respect to time and location, but have instances that occur at different dates, it should be appreciated, that times and/or locations may vary. For example, meeting may occur multiple times a day, at various locations, etc., such as “Planning Committee” having twice weekly meetings with fields of data structure 200 having values indicating: “Wednesday 10:00 in Conference Room B” and “Friday 11:30 in Conference Room A”. As a result, it should be appreciated that other data fields and/or other arrangement of the data fields illustrated by data structure 200 may be utilized.

Other fields of data structure 200, include repeat until field 224 of recurrence datum 214. If populated with a non-null value, repeat until field 224 indicates a date, time, or date-time, after which no further instances of the recurring scheduled event will occur. Presence state field 226 may be utilized to indicate presence data for scheduled resource 102 during instances of the recurring scheduled event, such as “busy,” “tentative,” “free,” “do not disturb,” or other status. Data structure 200 may also include other field 228 that may be utilized for other purposes associated with an event.

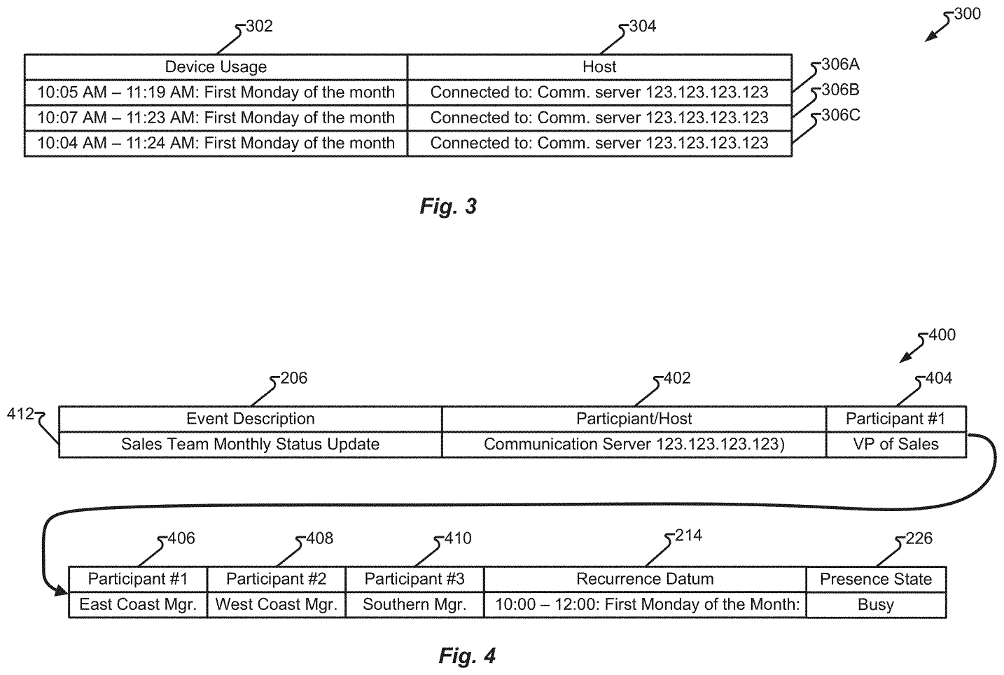

FIG. 3 depicts data structure 300 in accordance with embodiments of the present disclosure. In one embodiment, data structure 300 comprises a number of records 306 having a device usage field 302 and host field 304. Device usage field 302 creates one of records 306 for each instance that a particular device, such as device 104, is utilized or utilized for a purpose associated with an event, such as an in-person meeting or teleconference. Records 306 of data structure 300 may be created and/or accessed by one or more processors, such as of computer 106 and/or device 104, and maintained in device utilization repository 108.

Data structure 300 illustrates examples where scheduled resource 102 utilizes device 104 to connect to a communication server, such as a telephone number, telecommunication bridge, Session Initiation Protocol (SIP) endpoint address, etc. Data structure 300 omits certain fields for the purpose of avoiding unnecessarily complicating the figure and description, for example, a user identifier, record number, device identifier, etc. may be utilized in or in association with data structure 300.

FIG. 4 depicts data structure 400 in accordance with embodiments of the present disclosure. In one embodiment, data structure 400 utilizes, in whole or in part, fields of data structure 200 (see, FIG. 2). Data structure 400 comprises record 412 having event description field 206, recurrence datum 214, presence state field 226, and participant host block 210 (not shown) comprising participant host fields 402, 404, 406, 408, and 410, comprising embodiments of participant/host fields 212.

Record 412 comprises a number of entries for a particular recurring scheduled event for scheduled resource 102. In the example illustrated, scheduled resource 102 has a recurring scheduled event from 10:00 to 12:00 the first Monday of the month (see, recurrence datum 214), the recurring scheduled event utilizes a particular communication host (e.g., bridge, conference server, etc.) (see, participant/host field 402), which has four participants (see, participant host fields 406, 408, and 410), the meeting has the title of “Sales Team Month Status Update” (see, Event description field 206), and scheduled resource 102 has this time identified as “busy” (see, Presence state field 226).

Referring back to data structure 300 (See, FIG. 3), during the time of the recurring scheduled event identified in record 412, scheduled resource 102 utilized device 104, paired to scheduled resource 102. A discrepancy exists between the scheduled time of the meeting (recurrence datum 214) and the times of utilization (device usage field 302 or records 306A-C). In this example, the scheduled resource 102 utilizes device 104 to call into the communication server utilized for the “Sales Team Monthly Status Meeting” several minutes later than when the meeting is scheduled to start and terminates usage of device 104 over thirty minutes before the scheduled end time.

As will be discussed more completely in the embodiments that follow, the discrepancy may be resolved by modifying record 412, such as to adjust the start/end times (e.g., modify recurrence datum 214), modify the presence (e.g., busy to tentative), and/or create one or more records for data structure 400. For example, additional records may be created, such as to indicate that time from the meeting's scheduled start until the observed starting time (from device utilization field 302), several minutes later, and/or the time scheduled resource 102 ends the call (also from device utilization field 302) until the scheduled end (from the recurrence datum 214) may be created comprising a different value for the presence state field (e.g., “tentative,” “available,” etc.). A new or modified entry for the attended portion of the meeting (e.g., a few minutes past 10:00 until a few minutes before 11:30) may then remain with “busy” as the value for presence state field 226. Accordingly, a recurring scheduled event that is only partially attended by scheduled resource 102 may be more accurately reflected in the calendar, via entries in calendar data repository 110, for scheduled resource 102.

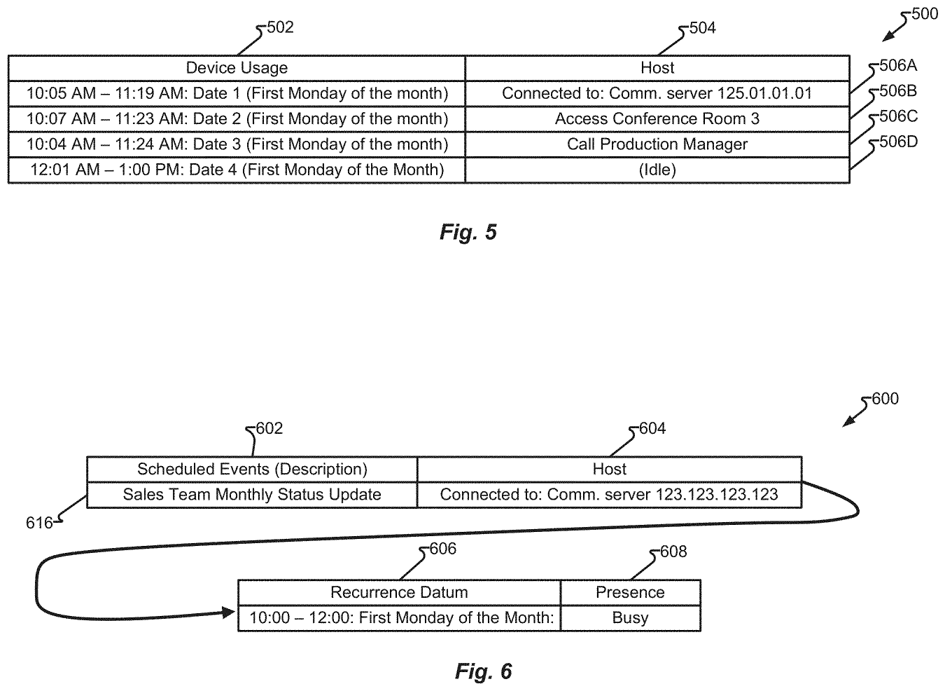

FIG. 5 depicts data structure 500 in accordance with embodiments of the present disclosure. In one embodiment, data structure 500 comprises records 506 having fields comprising, device utilization field 402 and host field 504 and may comprise, at least in part, data structure 200 and maintained in device utilization repository 108. Data structure 500 may be created and/or utilized by at least one processor, such as of device 104 and/or computer 106. In one embodiment, data structure 500 illustrates the usage of device 104 for scheduled resource 102. More specifically, utilization of device 104, during the time indicated in device usage field 502 for record 506A, is to connect to a particular communication server. During the time indicated in device usage field 502 for record 506B, device 104 is utilized to access a physically constrained resource, during the time indicated in device usage field 502 for record 506C, device 104 is utilized to make a phone call; and during the time indicated in device usage field 502 for record 506D, the device is idle. As will now be described with respect to FIG. 6, a discrepancy exists.

FIG. 6 depicts data structure 600 in accordance with embodiments of the present disclosure. In one embodiment, data structure 600 may utilize, in whole or in part, fields of data structure 200 (see, FIG. 2) and be maintained in calendar data repository 110. Accordingly, data structure 600 comprises description field 602, host field 602, recurrence datum field 606, and presence state field 608.

In one embodiment, scheduled resource 102 is scheduled for a recurring meeting from 10:00 until 12:00 on the first Monday of the month where device 104, paired with scheduled resource 102, is to connect to a particular communication server (see, field 604). However, at the time and day of a first instance device 104 is connected to a different communication server (see record 506A of data structure 500), during a second instance device 104 accesses a conference room (see record 506B of data structure 500), during a third instance device 104 is utilized to place a call to a different party (see record 506C of data structure 500), and during a fourth instance device 104 is idle (see record 506D of data structure 500). Accordingly, at least one processor of a computer, such as a processor of computer 106, may determine a discrepancy exists and, in particular, scheduled resource 102 is not attended the event indicated by record 616 and reflected in the calendar for scheduled resource 102. Accordingly, the record may be modified, such as to change the value of presence field 608 from “busy” to “tentative” or “free” or to delete record 616.

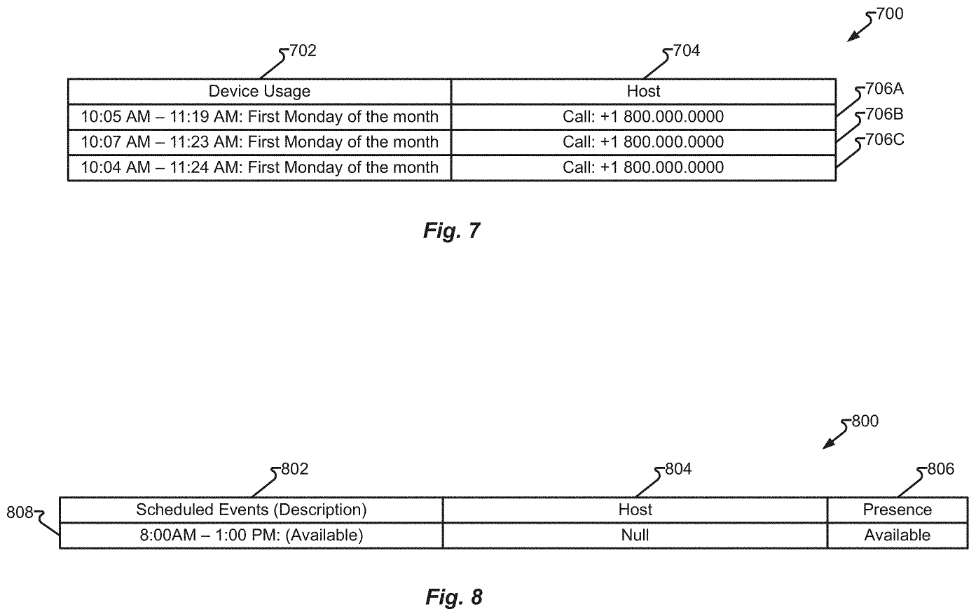

FIG. 7 depicts data structure 700 in accordance with embodiments of the present disclosure. Scheduled resource 102 may attend a recurring event that is not present on the calendar for scheduled resource 102. In one embodiment, data structure 700 records utilization of device 104 for paired scheduled resource 102. Data structure 700 comprises records 706 having device usage field 702 and host field 704 and may be maintained in device utilization repository 108.

In one embodiment, records 706 indicate that at a particular repeating pattern (e.g., the first Monday of the month), device 104 is utilized to make a telephone call to the same number. At least one processor, such as one of computer 106, may determine that the occurrence of calls to the same number (e.g., multiple entries to the same number within host field 704) at a recurring time/date, may indicate that scheduled resource 102 is attending a recurring event. As will be described more completely with respect to FIG. 8 below, a discrepancy may be determined to exist, such a recurring event may be absent from the calendar for scheduled resource 102.

FIG. 8 depicts data structure 800 in accordance with embodiments of the present disclosure. Data structure 800 may comprise, in whole or in part, data structure 200 and be maintained in calendar data repository 110. Data structure 800 comprises record 808 having field description field 802, host field 804, and presence field 806. In one embodiment, scheduled resource 102 has calendar entries maintained by data structure 600 which indicate, via record 808, that scheduled resource 102 is available at the same time that calls have previously been made to the same number, as indicated by data structure 700.

At least one processor, such as of computer 106, may determine that records 706 of data structure 700 (see, FIG. 7) are to a common host, as indicated by values of host field 704. Then, whether there is commonality with the occurrence of such calls or connections. In this case the times are the same, or are at least the same within a previously determined margin of error (e.g., five minutes, 10% of the overall duration of the event, etc.), as indicated by device usage field 702 for records 706A-C. Additionally, there is a predictability indicator, the dates of the instances (paraphrased as the “First Monday of the month”) are determined to have a common occurrence attribute (e.g., the first Monday of the month). Accordingly, the at least one processor may modify data structure 800 to add a recurring event for the first Monday of the month to the calendar of scheduled resource 102. The record may be merely a reminder or a presence value of “tentative” in presence field 606, until scheduled resource 102 confirms attendance or a certain number of subsequent occurrence also indicate attendance, after which presence field 606 may be changed to “busy” or similar indication that scheduled resource 102 is engaged.

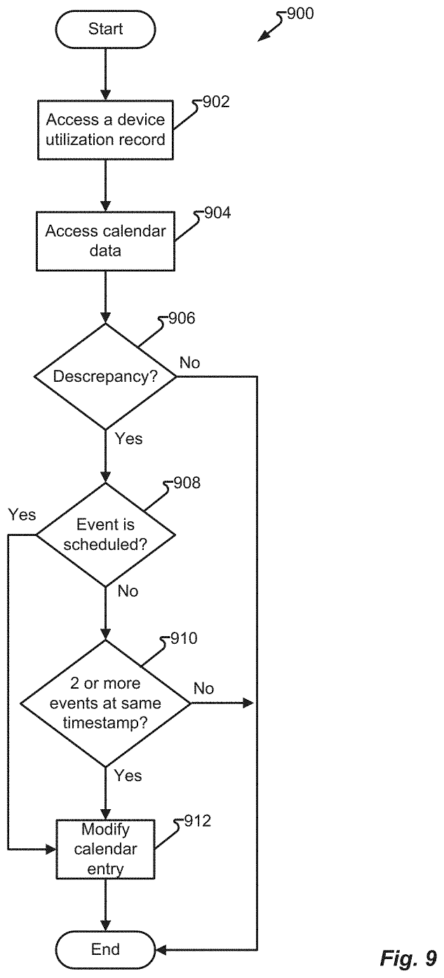

FIG. 9 depicts process 900 in accordance with embodiments of the present disclosure. In one embodiment, scheduled resource 102 paired with device 104, may attend a recurring scheduled event that is not present on their calendar (e.g., entries in calendar data repository 110 for scheduled resource 102 are absent any occurrence of a recurring utilization of device 104 as maintained in device utilization repository 108). Accordingly, at least one processor, such as a processor of computer 106 may execute instructions comprising process 900 whereby an attended (physically or remotely) recurring event may be added to the calendar for scheduled resource 102.

Process 900 begins and a device utilization record is accessed in step 902, such as by accessing data structure 300, 500, and/or 700 maintained in device utilization repository 108. Step 904 accesses calendar data, such as by accessing data structure 200, 400, 600, and/or 800 maintained in calendar data repository 110. Test 906 determines if a discrepancy exists between recurring events that are scheduled, from step 904, and the utilization of device 104, from step 902. A discrepancy exists, and test 906 is determined in the affirmative, if an event is scheduled but not attended, in whole or in part, or not scheduled but attended.

If test 906 is determined in the negative, process 900 may end or repeat at a later time for the same or different scheduled resource 102. If test 906 is determined in the affirmative, processing continues to test 908. Test 908 determines if the attended event is scheduled, by evaluating whether an entry exists for scheduled resource 102 within calendar data repository 110. If test 908 is determined in the affirmative then scheduled resource 102 is attended, at least partially (or in excess), and processing continues to step 912. If test 908 is determined in the negative, and the attended event is not scheduled, then processing continues to test 910. Test 908, which follows a determination of discrepancy in test 906, may indicate that scheduled resource 102 attends the scheduled event at a different start/end time than that which is scheduled for the event (e.g., start/stop early/late). As a result, step 912 may modify the calendar of scheduled resource 102 in reflect actual start/stop times.

Test 910 determines whether there is commonality with the time and/or date of the occurrence, then the individual instances may be considered to be part of a recurring event. Similarly, if other participants (e.g., users associated with participant device 116, participant device 120, participant device 122) are also the same or the same, within a previously determined margin of error, the instances may be considered common to the same recurrent event. Conversely, different participants may from one instance to another may be an indication that the events are not instances of the same recurring event.

The determination if two or more attended events are instances of the same recurring event is variously embodied. For example, scheduled resource 102 may be in a particular physical location, as indicated by step 902 finding device 104 proximate to location dependent device 114 (e.g., a conference room) or making a telephone call or teleconference connection to the same number of host.

Instances may be further evaluated for time and/or date. For example, a first occurrence has the attributes of “Tuesday”, “the 10^{th}”, “the 100^{th} day of the year, in non-leap year”, “first Tuesday following the first calendar quarter” and a second occurrence has the attributes of “Tuesday”, “the 6^{th}”, “the 191^{st} day of the year, in non-leap year”, “second Tuesday following the first calendar quarter”, and a third occurrence has the attributes of “Tuesday”, “the 2^{nd}”, “the 283^{rd} day of the year, in non-leap year”, “first Tuesday following the third calendar quarter”, then commonality of the first Tuesday following the end of the calendar quarter may be determined. As a result, it may be further determined that scheduled resource 102 is attending a recurring scheduled event that occurs on the first Tuesday following the end of the calendar quarter. As can be appreciated, a determination may be made for day of the week, day of the month, etc. In another embodiment, events associated with scheduled resource 102 (e.g., maintained in calendar data repository 110) and/or other calendar repositories may be examined. For example, a company-wide calendar may have entries such as “Product update release” and instances of device utilization of device 104 for scheduled resource 102 may occur a common number of days (or weeks, months, hours, etc.) before or after. Accordingly, it may be determined that device 104 utilization, paired with scheduled resource 102, indicates attendance of a recurring event before/after a particular triggering event (e.g., a product update release).

In certain embodiments, commonality may be indeterminate. For example, scheduled resource 102 may utilize device 104 at the same time on the same day of the week. Accordingly, a generic “call” event may be added to the calendar without regard to the subject or the other participants. Additionally or alternatively, calling different numbers may be de facto evidence that commonality is not present and it is merely coincidence that the calls were made on similar times and days.

When test 910 is determined in the negative, process 900 may end. when test 910 is determined in the affirmative, processing continues to step 912 wherein one or more calendar entries may be modified. For example, if step 912 is executed directly following test 908, then scheduled resource 102 is determined to be attending a scheduled event but at different times (beginning and/or ending late and/or early). Accordingly, step 912 may modify one or more entries to indicate times that scheduled resource 102 is actually attended and may further indicate times of non-attendance as “tentative,” or “free” or remove the times of non-attendance from the calendar to otherwise indicate availability. Similarly, attendance is entirely absent, calendar entries may wholly identify as “tentative,” “free”, or removed from the calendar of scheduled resource 102.

When step 912 is executed following test 910, device 104 is attended an event that is determined to be occurrences of the same recurring event. Accordingly, step 912 adds at least one entry to indicate the scheduled resource 102 is (e.g., presence is “busy”) or is likely (e.g., presence is “tentative”) to attend the event. The presence state may be selected, at least in part, on the number of common events, previously configured setup, or in response to user prompt to scheduled resource 102.

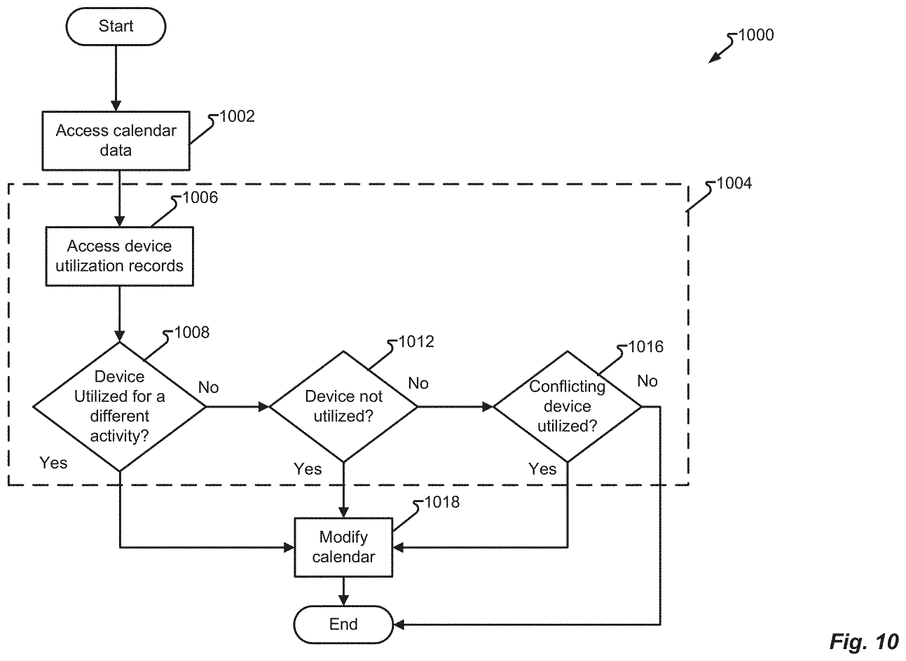

FIG. 10 depicts process 1000 in accordance with embodiments of the present disclosure. Absence of attendance by scheduled resource 102 at a particular event may be determined by utilization of device 104 for a different activity. In one embodiment, process 1000 is executed by at least one processor, such as of computer 106. Process 1000 begins and step 1002 accesses calendar data, such as by accessing data structure 200, 400, 600, and/or 800 maintained in calendar data repository 110. Next processing block 1004 determines if data obtained in step 1002 indicates a lack of attendance of an event.

Processing block 1004 may comprise one or more steps that, that may indicate scheduled resource 102 is absent from a scheduled event. For example, step 1006 may access a conflicting device utilization record, such as by accessing data structure 300, 500, and/or 700 maintained in device utilization repository 108. For example, if a scheduled event requires the utilization of device 104 to conduct a telephone call to a particular number, but instead device 104 is utilized to participate in a teleconference, connecting to a different host, then test 1008 is determined in the affirmative and scheduled resource 102 is absent from the scheduled event comprising the telephone call. If test 1008 is determined in the negative, test 1012 may determine if device 104 was idle during such a time. For example, an event comprising a telephone call to a particular number may require utilization of device 104. However, if device 104 was idle during such a time, test 1012 may be determined in the affirmative. If test 1012 is determined in the negative, test 1016 may determine if a conflicting device was utilized. For example, if a scheduled event required participation via video (such as device 104B embodied as a computer with an associated camera, microphone, speakers, video display, etc.) but during the event, device 104C, embodied as a voice-only telephone is utilized, then test 1016 may be determined in the affirmative. If each of test 1008, 1012, and 1016 are determined in the negative, then scheduled resource 102 may be determined to be attended a scheduled event. In contrast if any one of test 1008, 1012, or 1016 are determined in the affirmative, scheduled resource 102 is determined to be absent from the event and step 1018 modifies the record associated with the, non-attended, event.

Step 1018 may alter the presence of the event on the calendar of scheduled resource 102, for example, from “busy” to “tentative” or “free”, change the format of the calendar entry from an event to a reminder, or remove the event from the calendar.

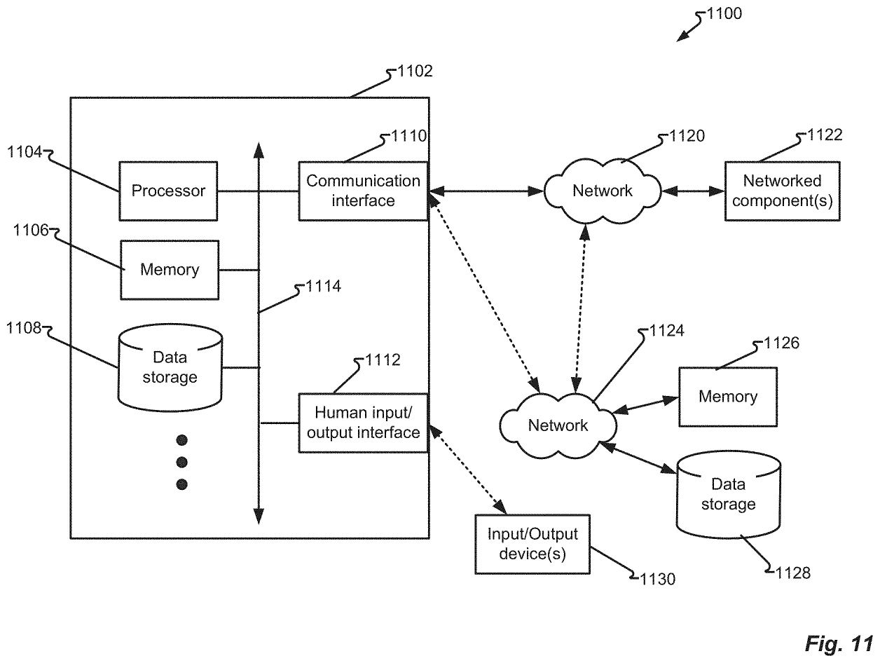

FIG. 11 depicts device 1102 in system 1100 in accordance with embodiments of the present disclosure. In one embodiment, device 104 and/or computer 106 may be embodied, in whole or in part, as device 1102 comprising various components and connections to other components and/or systems. The components are variously embodied and may comprise processor 1104. Processor 1104 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 1114, executes instructions, and outputs data, again such as via bus 1114.

In addition to the components of processor 1104, device 1102 may utilize memory 1106 and/or data storage 1108 for the storage of accessible data, such as instructions, values, etc. Communication interface 1110 facilitates communication with components, such as processor 1104 via bus 1114 with components not accessible via bus 1114. Additionally or alternatively, input/output interface 1112 connects to one or more interface components to receive and/or present information (e.g., instructions, data, values, etc.) to and/or from a human and/or electronic device. Examples of input/output devices 1130 that may be connected to input/output interface include, but are not limited to, keyboard, mouse, trackball, printers, displays, sensor, switch, relay, etc. In another embodiment, communication interface 1110 may comprise, or be comprised by, input/output interface 1112. Communication interface 1110 may be configured to communicate directly with a networked component or utilize one or more networks, such as network 1120 and/or network 1124.

Network 112 may be embodied, in whole or in part, as network 1120. Network 1120 may be a wired network (e.g., Ethernet), wireless (e.g., WiFi, Bluetooth, cellular, etc.) network, or combination thereof and enable device 1102 to communicate with network component(s) 1122.

Additionally or alternatively, one or more other networks may be utilized. For example, network 1124 may represent a second network, which may facilitate communication with components utilized by device 1102. For example, network 1124 may be an internal network to contact center, enterprise, educational institution, etc. whereby components are trusted (or at least more so) that networked components 1122, which may be connected to network 1120 comprising a public network (e.g., Internet) that may not be as trusted. Components attached to network 1124 may include memory 1126, data storage 1128, input/output device(s) 1130, and/or other components that may be accessible to processor 1104. For example, memory 1126 and/or data storage 1128 may supplement or supplant memory 1106 and/or data storage 1108 entirely or for a particular task or purpose. For example, memory 1126 and/or data storage 1128 may be an external data repository (e.g., server farm, array, “cloud,” etc.) and allow device 1102, and/or other devices, to access data thereon. Similarly, input/output device(s) 1130 may be accessed by processor 1104 via input/output interface 1112 and/or via communication interface 1110 either directly, via network 1124, via network 1120 alone (not shown), or via networks 1124 and 1120.

It should be appreciated that computer readable data may be sent, received, stored, processed, and presented by a variety of components. It should also be appreciated that components illustrated may control other components, whether illustrated herein or otherwise. For example, one input/output device 1130 may be a router, switch, port, or other communication component such that a particular output of processor 1104 enables (or disables) input/output device 1130, which may be associated with network 1120 and/or network 1124, to allow (or disallow) communications between two or more nodes on network 1120 and/or network 1124. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising:
a computer having at least one processor and memory accessible to the at least one processor;
a device utilization repository comprising a device utilization record of a device provided by the device that is paired with a scheduled resource; and
a calendar data repository comprising scheduled activities of the scheduled resource; and
wherein the computer performs a determination of a discrepancy between attendance of a recurring scheduled activity and device utilization record concurrent with the recurring scheduled activity; and
wherein upon determining the discrepancy, the computer, performs a modification to a subsequent instance of the recurring scheduled activity, wherein the modification attenuates the difference between the recurring scheduled activity and the device utilization record.

2. The system of claim 1, wherein the determination of the discrepancy further comprises, performing a determination of non-attendance of the scheduled resource of at least a portion of a first instance of the recurring scheduled activity upon determining the at least a portion of the first instance of the recurring scheduled activity differs from the device utilization record.

3. The system of claim 2, wherein the modification to the subsequent instance of the recurring scheduled activity comprises one or more of decreasing the difference between a scheduled start time of the recurring scheduled activity and a start time of the device utilization record, decreasing the difference between a scheduled end time of the recurring scheduled activity and a start time of the device utilization record, marking the subsequent instance of the recurring scheduled activity as tentative, marking the subsequent instance of the recurring scheduled activity as available, replacing the subsequent instance of the recurring scheduled activity with a reminder, marking the subsequent instance of the recurring scheduled activity as busy but available for other purposes, and deleting the subsequent instance of the recurring scheduled activity as available from the calendar data repository.

4. The system of claim 1, wherein the determination of the discrepancy further comprises, performing a determination of attendance by the scheduled resource of a first candidate event, wherein the scheduled activities of the scheduled resource do not indicate attendance of the first candidate event by the scheduled resource.

5. The system of claim 4, wherein the determination that the first candidate event and a second candidate event comprise instances of a recurring scheduled activity, comprises determining that the device utilization record was utilized at the same recurring date and time during both the first candidate event and the second candidate event, wherein the same recurring date and time have at least one of the same day of the week following or preceding a known recurring event maintained in the scheduled activities of the scheduled resource, the same day of the month following or preceding the known recurring event maintained in the scheduled activities of the scheduled resource, the same date of the month following or preceding the known recurring event maintained in the scheduled activities of the scheduled resource, the same day of the quarter following or preceding the known recurring event maintained in the scheduled activities of the scheduled resource, or the same day of the year following or preceding a known recurring event maintained in the scheduled activities of the scheduled resource.

6. The system of claim 1 wherein the modification to the subsequent instance of the recurring scheduled activity comprises a modification to all subsequent instances of the recurring scheduled activity.

7. A method, comprising:
accessing a device utilization repository comprising a device utilization record of a device provided by a device paired with a scheduled resource;
accessing a calendar data repository comprising scheduled activities of the scheduled resource;
performing a first determination of non-attendance of the scheduled resource of at least a portion of a first instance of a recurring scheduled activity upon determining the first instance of the recurring scheduled activity differs from the device utilization record; and
upon the first determination of non-attendance, performing a modification to a subsequent instance of the recurring scheduled activity, wherein the modification attenuates the difference between the recurring scheduled activity and the device utilization record.

8. The method of claim 7, wherein determining the at least a portion of the first instance of the recurring scheduled activity differs from the device utilization record comprises determining the difference is greater than a threshold difference between device utilization record, concurrent with the at least a portion of the first instance of the recurring scheduled activity, and the first instance of the recurring scheduled activity.

9. The method of claim 7, wherein the modification to the subsequent instance of the recurring scheduled activity comprises one or more of decreasing the difference between a scheduled start time of the recurring scheduled activity and a start time of the device utilization record, decreasing the difference between a scheduled end time of the recurring scheduled activity and the start time of the device utilization record, marking the subsequent instance of the recurring scheduled activity as tentative, marking the subsequent instance of the recurring scheduled activity as available, replacing the subsequent instance of the recurring scheduled activity with a reminder, marking the subsequent instance of the recurring scheduled activity as busy but available for other purposes, and deleting the subsequent instance of the recurring scheduled activity as available from the calendar data repository.

10. The method of claim 7, wherein the modification to the subsequent instance of the recurring scheduled activity comprises a modification to all subsequent instances of the recurring scheduled activity.

11. The method of claim 7, wherein accessing the device utilization record comprises receiving a utilization signal from the device indicating at least one of utilization, absence of utilization, transition from utilized to unutilized, or transition from unutilized to utilized.

12. The method of claim 7, wherein accessing the device utilization record comprises accessing a utilization record of a conflicting device, wherein at least one of utilization of the conflicting device indicates non-utilization of the device or non-utilization of the conflicting device indicates utilization of the device.

13. The method of claim 7, wherein accessing the device utilization record comprises accessing a utilization record of a conflicting activity of the device, wherein at least one of utilization of the device for the conflicting activity indicates non-attendance of at least a portion of the scheduled activity or non-utilization of the device for the conflicting activity indicates attendance of the scheduled activity.

14. The method of claim 7, wherein accessing the device utilization record comprises accessing a location record of a location device indicating a location of the scheduled resource and wherein at least one of proximity of the location device to the device indicates utilization of the device or an absence of proximity of the location device to the device indicates non-utilization of the device.

15. A method, comprising:
accessing a device utilization repository comprising a device utilization record of a device provided by the device paired with a scheduled resource;
accessing a calendar data repository comprising scheduled activities of the scheduled resource;
performing a first determination of attendance by the scheduled resource of a first candidate event, wherein the scheduled activities of the scheduled resource do not indicate attendance of the first candidate event by the scheduled resource;
performing a second determination of attendance by the scheduled resource of a second candidate event, wherein the scheduled activities of the scheduled resource do not indicate attendance of the second candidate event;
determining the first candidate event and the second candidate event comprise instances of a recurring scheduled activity; and
upon the first candidate event and the second candidate event are instances of the same recurring scheduled activity, performing a modification to a subsequent instance of the recurring scheduled activity, wherein the modification provides indicia of attendance of the subsequent instance of the recurring scheduled activity.

16. The method of claim 15, wherein the determination that the first candidate event and the second candidate event comprise instances of the recurring scheduled activity, comprises determining that the device utilization record was utilized to connect to the same number during both the first candidate event and the second candidate event.

17. The method of claim 15, wherein the determination that the first candidate event and the second candidate event comprise instances of the recurring scheduled activity, comprises determining that the device utilization record was utilized to connect to at least one participant that is the same during both the first candidate event and the second candidate event.

18. The method of claim 15, wherein the determination that the first candidate event and the second candidate event comprise instances of the recurring scheduled activity, comprises determining that the device utilization record was utilized at the same recurring date and time during both the first candidate event and the second candidate event, wherein the same recurring date and time have at least one of the same day of the week, same day of the month, same date of the month, same day of the quarter, or same day of the year.

19. The method of claim 15, wherein the determination that the first candidate event and the second candidate event comprise instances of the recurring scheduled activity, comprises determining that the device utilization record was utilized at the same recurring date and time during both the first candidate event and the second candidate event, wherein the same recurring date and time have at least one of the same day of the week following or preceding a known recurring event maintained in the scheduled activities of the scheduled resource, the same day of the month following or preceding the known recurring event maintained in the scheduled activities of the scheduled resource, the same date of the month following or preceding the known recurring event maintained in the scheduled activities of the scheduled resource, the same day of the quarter following or preceding the known recurring event maintained in the scheduled activities of the scheduled resource, or the same day of the year following or preceding the known recurring event maintained in the scheduled activities of the scheduled resource.

20. The method of claim 15, wherein the step of performing the modification to the subsequent instance of the recurring scheduled activity, further comprises at least one of creating a calendar entry for the subsequent instance of the recurring scheduled activity, creating a calendar entry for the subsequent instance of the recurring scheduled activity marked as tentative, creating the calendar entry for the subsequent instance of the recurring scheduled activity marked as unavailable, creating a reminder entry for the subsequent instance of the recurring scheduled activity, creating an entry for the subsequent instance of the recurring scheduled activity marked as busy but available for other purposes.
